(19) United States
(12) Patent Application Publication
(10) Pub. No.: US 2007/0204477 A1
(43) Pub. Date: Sep. 6, 2007

(54) Heat generating mechanism for hair dryer

(76) Inventor: Cheng Ping Lin, Taipei (TW)

Correspondence Address: BRUCE H. TROXELL, SUITE 1404, 5205 LEESBURG PIKE, FALLS CHURCH, VA, 22041, US

(21) Appl. No.: 11/366,563

(22) Filed: Mar. 3, 2006

(51) Int. Cl. A45D 20/12; H05B 6/12

(52) U.S. Cl. 34/96; 219/626

(57) ABSTRACT

Disclosed is a heat generating mechanism for hair dryer having a housing in which accommodating a fan, a motor, and a heat generating mechanism which employs a ceramic block as a heat generating element, and an electrically conducting reed and a heat shield ring are respectively attached to both front and rear ends of the ceramic block. The ceramic block is a beehive figured porous body having a central main axial passage in which a temperature sensor switch is axially inserted.

### FIELD OF THE INVENTION

The present invention relates to heat generating mechanism for hair dryer, and more particularly, to a beehive figured porous ceramic heat generating structure in which a temperature sensor switch is axially equipped along a central main passage of the ceramic block so as to detect the temperature in the ceramic block in the shortest time.

### DESCRIPTION OF THE PRIOR ART

In the latest Taiwan local Utility Model Patent M263023, a new hair dryer is disclosed. The housing of the hair dryer is composed of two corresponding right and left sub-housings coupled together. The housing equipped with a wind outlet grids and a wind inlet net, contains an electric circuit control unit, a fan, a motor, a filter, and a motor voltage lowering unit in it. With the operation of the electric circuit control unit, the motor is rotated to drive the fan so as to introduce the air into the housing from the wind inlet and blow the air out of the housing via wind outlet grids. A negative iron generator, and a ceramic block are respectively provided at the rear and the front terminals of the motor voltage lowering unit. Each of the two terminals of the ceramic block is covered by an electric conducting metallic layer and a heat shield layer, and the ceramic block is fixed at its position outside the two heat shield layers with fixing means. With such a structure, when the negative ion generator and the two metallic layers are actuated, the negative ions produced by the negative ion generator are blown out of the wind outlet grids so as to preserve the moisture in the user's hairs, the far infrared ray emitted by the energized ceramic block pierce deeply through the user's skin into the inner organization thereby improving the blood circulation.

It is understood that using a ceramic block with the hair dryer to generate heat is but a known prior technique. However, it is problematic that the ceramic block is apt to crack, become frangible, or even completely break under an excessively high temperature. Besides, the motor voltage lowering unit is conventionally made of an electric heater wire enclosed in a flat mica envelope, the contact surface of the mica with the high temperature heater wire will be exfoliated after a long time operation. The mica in a high temperature produces poisonous, dissoluble, and in-expellable particles which are severely harmful to human health after inhaling into the lungs.

It is what the reason the inventor has plunged into this matter by continuous research and experimentation attempting to find out the remedy to palliate the inherent shortcomings of the conventional techniques described above, and at last has succeeded in realizing the present invention.

### SUMMARY OF THE INVENTION

Accordingly, it is an object of the present invention to provide a heat generating mechanism for hair dryer wherein the operating temperature of the ceramic block inside can be timely detected so as to protect the hair dryer from overheating thereby prolonging its lifespan.

To achieve the object, the present invention provides a beehive figured porous ceramic block in which a temperature sensor switch and an overheat protection fuse electrically connected with each other are axially disposed along a central main passage formed in the ceramic block so as to timely interrupt the power supply in the emergency of over-temperature.

The present invention also utilizes a porous ceramic block as a motor voltage lowering element. By using the stable heat generation characteristic and ability of maintaining uniform temperature, the ceramic block serves the functions of stabilizing and lowering the motor voltage when it is electrically connected with the motor, such that the conventional detect of the mica envelope exfoliation due to overheating of motor voltage lowering element will no more happen again.

The above object and other advantages of the present invention will become more apparent by describing in detail the preferred embodiment of the present invention with reference to the following attached drawings.

### BRIEF DESCRIPTION OF THE DRAWINGS

FIG. 1 is a cross sectional view of the hair dryer of the present invention.

FIG. 2 is a perspective view of the heat generating mechanism for hair dryer according to the present invention.

FIG. 3 is a three dimensional exploded view of the heat generating mechanism for hair dryer according to the present invention.

FIG. 4 is a front view of the heat generating mechanism for hair dryer according to the present invention.

### DETAILED DESCRIPTION OF THE PREFERRED EMBODIMENT

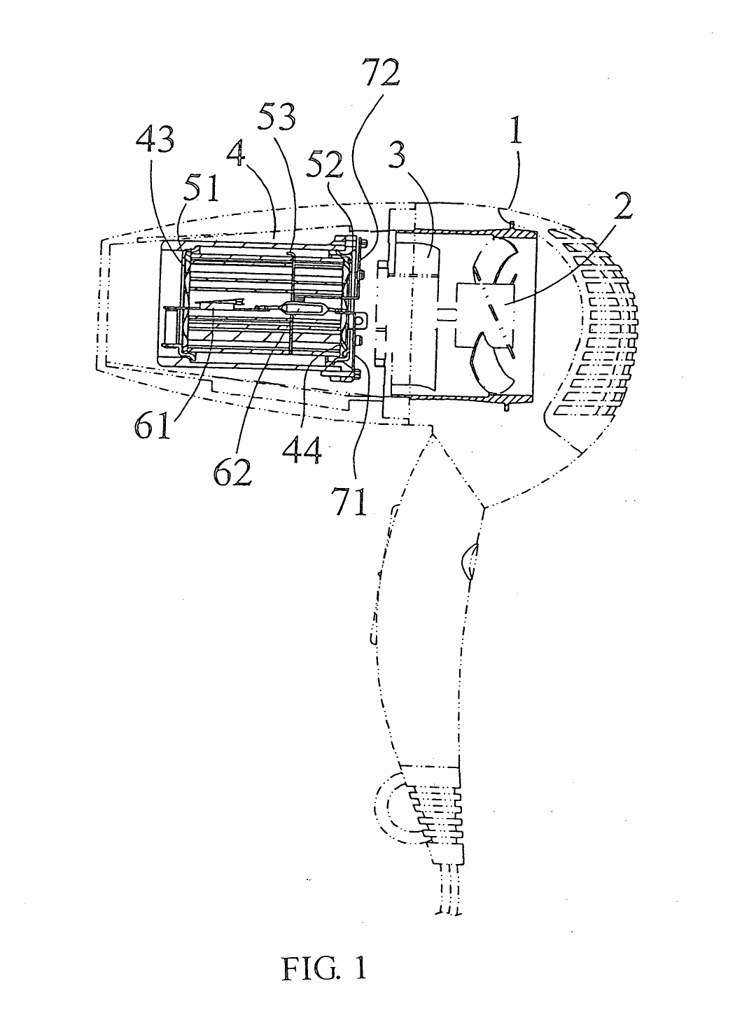

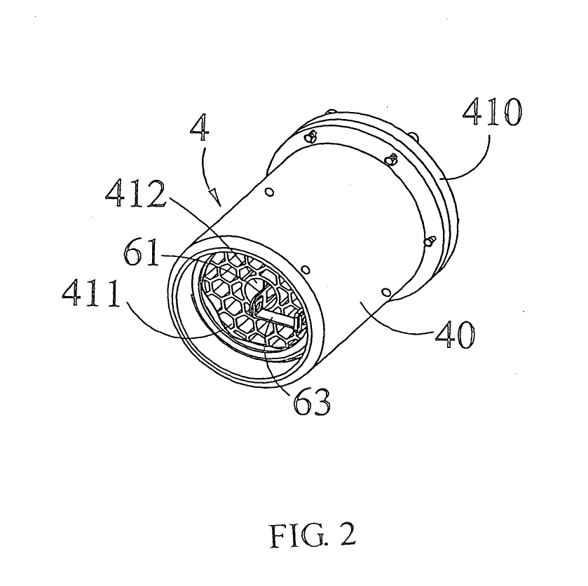

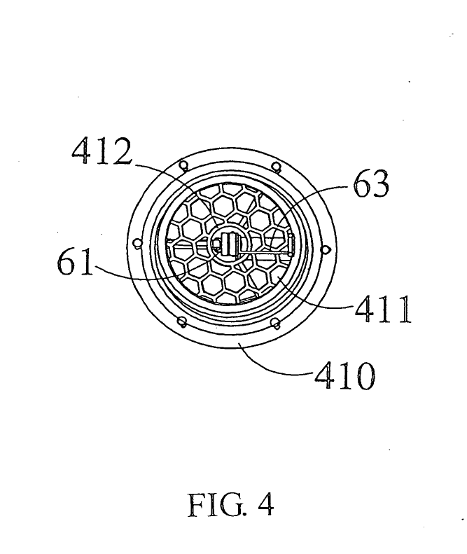

Referring to FIG. 1 through FIG. 4, the hair dryer according to the present invention has a housing 1 accommodating a fan 2, a motor 3, and a heat generating mechanism 4 in it. The heat generating mechanism 4 is composed of a first ceramic block 41, a second ceramic block 42, several electrically conducting reeds 43, 44 being attached to the two ceramic blocks 41, 42, and several heat shield rings 51, 52 attached to the aforesaid reeds, the whole structure is enclosed by an envelope 40.

Both the first and second ceramic blocks 41 and 42 are provided with a number of beehive like through pores 411, 421 . . . , and further have main passages 412 an 422 respectively formed axially at their center portions, and both passages 412, 422 are communicated with each other, an electrically conducting ring 53 is intercalated between the two ceramic blocks 41 and 42. The aforesaid electrically conducting reeds 43 and 44 are respectively attached to the outer ends of the ceramic blocks 41 and 42, the other sides of the reeds 43 and 44 are respectively necked by the aforesaid heat shield rings 51 and 52.

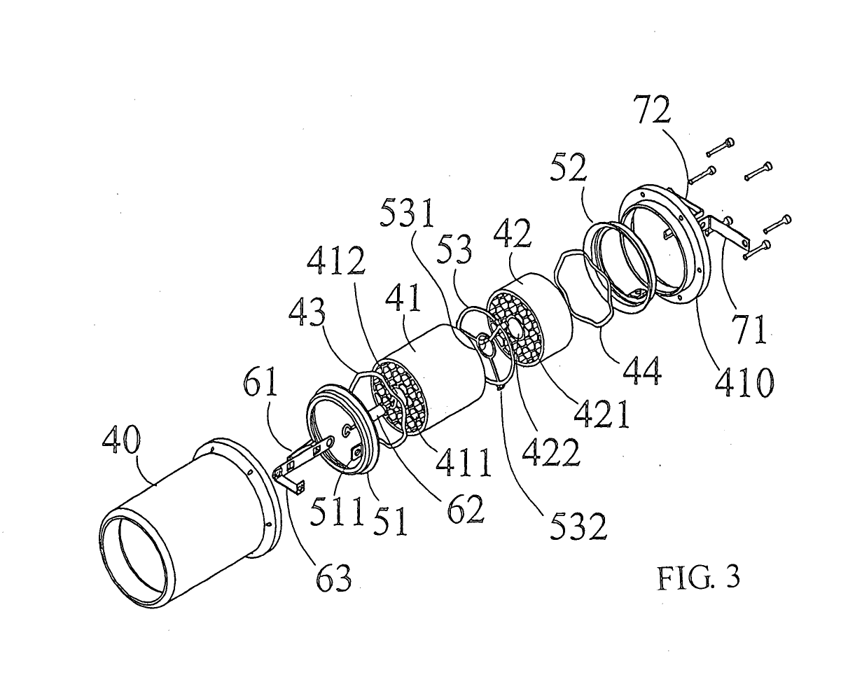

As shown in FIG. 3, a temperature sensor switch 61 and an overheat protective fuse 62 are inserted axially into the main passages 412 and 422 of the ceramic blocks 41 and 42. The temperature sensor switch 61, which being in connection with the overheat protective fuse 62 at its one end, is provided with a transversely emerged pawl 63 fixedly hooked onto a protruded eye lug 511 on the heat shield ring 51, while the end of the fuse 62 opposite to the switch 61 is fixedly connected to a first L shaped bracket 71 which being emerged its one end out of the heat generating mechanism and hidden the other end inside thereof.

Similarly, there is a second L shaped bracket 72 which emerges its one end out of the heat generating mechanism and extends the other end inside the heat generating mechanism to connect with the conducting ring 53 intercalated between the first and second ceramic blocks 41 and 42.

The electrically conducting ring 53 is configurated into an annular shape with a lead leg 531 radially extended from its hub, by so, the lead leg 531 is electrically in connection with the second L shaped bracket 72, and a contactor 532 is provided on its rim for in connection with the motor 3 using a conductor.

The heat shield ring 51, the electrically conducting reed 43, the first ceramic block 41, the electrically conducting ring 53, the second ceramic block 42, the electrically conducting reed 44, and the heat shield ring 52 are assembled in order and enclosed with the envelope 40 bolted onto an envelope ring 410 at its inner side, the outer side thereof is for engaging with the L shaped brackets 71 and 72.

After finishing assembly, the first ceramic block 41 serves as a heat generating element, while the second ceramic block 42 as a voltage lowering element, the outer end of the envelope ring 410 is engaged with the motor 3 with fixing means.

After the fan 2, the motor 3 and the heat generating mechanism 4 are put together as a whole hair dryer unit, being axially disposed respectively in the main passages 412 and 422 of the first and second ceramic blocks 41 and 42, the sensor switch 61 and fuse 62 are able to promptly and sensitively detect the variation of temperature in the ceramic blocks 41 and 42.

As soon as the overtemperature in the ceramic blocks 41 and 42 has been detected, the temperature sensor switch 61 and the overheat protective fuse 62 actuate to interrupt the power supply so as to protect the ceramic blocks 41 and 42. The aforesaid switch 61 and fuse 62 is usually connected in series, alternatively one of them is intermediately tapped out from the supply line.

The electrically conducting reeds 43, 44 intercalated between the ceramic blocks 41, 42 and attached to their ends are all corrugated on their surfaces so as to stably support the ceramic bodies 41 and 42 with their surface cushion effect.

After completing assembly of the heat generating mechanism by putting together the first and second ceramic blocks 41, 42, the electrically conducting reeds 43, 44 and the heat shield rings 51, 52 in the envelope 40, the heat generated from the ceramic blocks 41, 42 can be promptly conducted via the beehive figured pores 411, 421 formed on the ceramic blocks 41, 42 with an excellent efficiency.

As soon as the motor 3 is started, the ceramic blocks 41, 42 are also energized to generate heat and emit the far infrared ray along with the wind blow of fan 2 driven by the motor 3.

Practically, the number of the ceramic blocks 41 and 42 can be varied according to the power required by the hair dryer to meet the standards of different countries, that means it can be more than one.

The present invention is a high level technical creation and not simply utilizes conventional technology or knowledge known prior to the application for patent or can easily made by persons skilled in the arts. Prior to the application for patent, the invention has neither been published or put to public use, nor displayed in any exhibition therefore the present invention is eligible for application of patent.

Although the description above contains many specificities, these should not be construed as limiting the scope of the invention but as merely providing illustration of some of the presently preferred embodiment of this invention. Thus the scope of the invention should be determined by the appended claims and their legal equivalents, rather than by the examples given.

1. A heat generating mechanism for hair dryer being accommodated in a housing together with a motor and a fan, said heat generating mechanism comprising a ceramic block as a heat generating element, and an electrically conducting reed and a heat shield ring being respectively attached to both front and the rear end of said ceramic block; wherein said ceramic block is a beehive figured through porous block having a central main axial passage in which a temperature sensor switch is axially inserted.

2. The heat generating mechanism as claimed in claim 1, wherein an overheat protective fuse is axially disposed in the central main passage of said ceramic block.

3. The heat generating mechanism as claimed in claim 2, wherein said temperature sensor switch and said overheat protective fuse is connected in series, or one of them intermediately tapped out from the supply line.

4. The heat generating mechanism as claimed in claim 1, wherein said ceramic blocks contains a first block and a second block with an electrically conducting ring intercalated therebetween.

5. The heat generating mechanism as claimed in claim 4, wherein said second ceramic block is used as a motor voltage lowering element.

6. The heat generating mechanism as claimed in claim 4, wherein said electrically conducting ring interrelated between said first and second ceramic blocks has a lead lug radially extended from its hub to be in connection with a L shaped bracket outside of said ceramic blocks.

7. The heat generating mechanism as claimed in claim 3, wherein the other end of said temperature sensor switch in series with said overheat protective fuse is fixedly connected to said heat shield ring attached to the front end of said ceramic block.

8. The heat generating mechanism as claimed in claim 1, wherein the number of said ceramic block is one or more.

9. The heat generating mechanism as claimed in claim 1, wherein a surface of said electrically conducting reeds attached to both ends of said ceramic block are corrugated.
